(19) United States
(12) Patent Application Publication
(10) Pub. No.: US 2009/0094074 A1
(43) Pub. Date: Apr. 9, 2009

(54) Method for Constructing Business Process Models from Task Execution Traces

(76) Inventors: Daniel N. Nikovski, Cambridge, MA (US); Akihiro Baba, Fujisawa (JP)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/867,221

(22) Filed: Oct. 4, 2007

(51) Int. Cl. G06F 9/44

(52) U.S. Cl. 705/7

(57) ABSTRACT

A business process is modeled by determining, for each possible pair of tasks in a trace of executions of N tasks corresponding to a business process, whether the tasks in each pair have an identical relation condition with every other task in the trace. A pair of tasks is identified as child task nodes of an associated parent relation node if the identical relation condition is true. A renderable workflow tree is constructed from all identified child task of the associated corresponding parent relation, nodes.

### FIELD OF THE INVENTION

This invention relates generally to managing business processes, and more particularly to methods for constructing, organizing, representing, optimizing and modeling business processes.

### BACKGROUND OF THE INVENTION

Business Process Management

The organization and optimization of business processes within an enterprise is essential to the success of the enterprise. Business process management (BPM) uses methods and tools to design, control, and analyze business processes in the enterprises. The management of business processes using computer implemented methods is an important class of information technology (IT). A key to successful BPM is the expressive capability of the models that are used for representing the business processes, and the techniques used to construct, maintain, optimize, and analyze the models.

Graphic representations are used in most business process modeling applications. However, the specific types of models and the semantics associated with the models vary widely. Some of the more popular representations include finite state machines, Markov models, as well as special-purpose graphic formalisms such as workflow trees, and block diagrams.

One common representation uses a place/transition net or Petri net, first described by Carl Adam Petri in his 1962 PhD Thesis, see Peterson, James L. “Petri Nets” ACM Computing Surveys 9 (3): 223-252, 1977. As a modeling technique, a Petri net depicts graphically a structure of a business process as a directed bipartite graph with annotations. Therefore, the Petri net has place nodes, transition nodes, and directed arcs connecting places with transitions. Petri nets enable business process mining techniques for the analysis of business processes based on task execution traces. For example, the audit trails of a workflow management system, or the transaction log of an enterprise planning system. The traces can also be compared with some model to determine whether the observed data corresponds to the model.

In most cases, the graphical representations are associated with a corresponding formal language that is interpretable by BPM software. A number of standards are known, most notably BPMN, which is a notation for diagramming business processes, and BPEL4WS, which includes process description languages that can be directly executed by a business process management system. The abundance of modeling formalisms suggests that there is not a single best representation, but rather, multiple trade-offs exist when adapting formalisms to a particular process, and a wide choice of available formalisms is in fact beneficial.

Process Mining and Implicit Concurrency

The objective of process mining methods and systems is to construct (learn) an explicit business process model from a trace of task executions, see van der Aalst W. M. P., Weijters, A. J. M. M, “Process mining: a research agenda,” Comput. Ind. 53(3), pp. 231-244, 2004, incorporated herein by reference.

Herein after, a trace is defined as a record of a sequence of tasks that are executed while processing a work-case.

This functionality is especially useful when a new BPM system is deployed in an enterprise, and explicit models of the processes have to be produced as a starting point for analysis, process re-engineering, etc. The traditional alternative to process mining, i.e., a manual construction of process models, usually using graphic editors, can be very time and labor intensive, because it typically involves interviews with people. It is also very imprecise, because people can only describe the way they imagine business processes operate, and not the way these business processes actually operate.

At the same time, if the business processes already involve information technology, e.g., enterprise resource planning systems or customer relationship management systems, then execution traces from those systems already exist. In such cases, using those traces to automatically extract process models can result in major savings in time and effort and improve model accuracy significantly.

To this end, business process mining has been an active area of research and software development and engineering in recent years. The problem is to find a model of a business process, represented in a suitable formalism, solely by inspecting a relative order of tasks as manifested in trace collected from the repeated execution of the business process.

It is assumed that N different tasks tᵢi=1,N, tᵢ ε T, from the set of tasks T can be distinguished in the trace. The trace is partitioned into disjoint episodes that each corresponds to the processing of one work-case. During one episode, the work-case takes one possible path through the process. An episode is represented as a sequence of task executions, and indicates the sequential order of the tasks while a particular work-case was processed. The objective of process mining is to inspect the trace and induce a process model that could have produced this trace. It is usually desired that the induced model be as compact as possible.

It has been recognized that process mining is a special case of inductive machine learning (ML). Hence, generic ML techniques, most commonly based on heuristic search, are applicable to this problem. Examples of this approach include the methods of Cook and Wolf, see Cook, J. E., Wolf, A. L., “Discovering models of software processes from event-based data,” ACM Trans. Softw. Eng. Methodol. 7(3) pp. 215-249, 1998, incorporated herein by reference. Those methods employ greedy induction over model spaces representing Markov models and Petri nets.

While successful, the heuristic nature of a search in the model spaces does not guarantee the discovery of the optimal model, where optimally is usually defined as a trade-off between model accuracy and parsimony, much like in other machine learning problems. Further complicating the problem of finding the optimal model is the issue of data sufficiency and certainly, if the exact relationship among tasks is not manifested in the trace, a correct, and much less, optimal model cannot be learned from the trace.

A major shift from heuristic search and inductive methods occurred with the emergence of constructive algorithms, such as α, α+, and β, see van der Aalst, W., Weijters, T., Maruster, L., “Workflow mining: Discovering process models from event logs,” IEEE Transactions on Knowledge and Data Engineering 16(9) pp. 1128-1142, 2004, incorporated herein by reference.

Those methods pre-compute the relations between each pair of tasks as manifested in the trace, and organize the identified relations in a table. After that, the methods construct a model based only on this table, without having to reexamine the trace. This approach effectively renders the complexity of the mining part independent of the size of the trace, which can be a very favorable property when large traces have to be mined. Furthermore, by making the assumption that the relation table is correct, the ability of the method to find the optimal model can be analyzed in isolation from any data sufficiency and sample complexity issues.

The best known example of this class of constructive algorithms is the α algorithm described by van der Aalst et al. The business process representation used by that algorithm is a structured workflow net (SWF-net). This is a carefully selected and precisely defined subset of Petri nets that avoids undesirable situations, such as deadlocks, incomplete tasks, indeterminate synchronization, etc.

While the restrictions of the SWF-net with respect to general Petri nets are fairly significant, van der Aalst et al. state that the SWF-net in fact matches the type of processes that exist in the real world, correspond to the constructs used in most deployed workflow systems, and also result in process descriptions that are easier to understand and maintain by users.

A significant novel idea of the α algorithm is to pre-process the trace and determine the pair-wise relations between all pairs of tasks. The four possible trace-based ordering relations between a pair of tasks a and b are:
i) a>b if and only if (iff) there exists at least one episode in the trace where task a is executed immediately before (>) task b;
ii) a→b iff a>b and b≯a, where ≯ means does not precede;
iii a#b iff a≯b and b≯a; and
iv) a∥b iff a>b and b>a, where < indicates after.

The assumption of these algorithms is that the trace is complete. That is, the trace reflects correctly the relations between the executions of the tasks in the business process that produced the trace. In practice, this requirement means that if all tasks that can potentially follow each other, the tasks do so in at least one trace.

After the relation between each pair of tasks has been identified to be one of these four relations, the algorithm proceeds to construct a minimal SWF-net that satisfies the relations. Based on the provable property that a→b implies that a SWF-net place exists immediately between tasks a and b. van der Aalst et al. devised an algorithm that constructs an SWT-net in eight steps, without any heuristic search.

The key step of the algorithm is to identify pairs Y of maximal sets of tasks A and B, such that all tasks in the set A have relation # between each other, similarly, all tasks in the set B have relation # between each other. For any pair of tasks a in the set A and task b in the set B, it is true that a→b. No supersets of A and B, respectively, exhibit these properties. When such a task pair (A, B) has been identified, the algorithm constructs a new place P of the SWF-net, adds transitions from all tasks a in the set A to P, and transitions from P to all tasks b in the set B.

The α algorithm is able to mine a large class of SWF-nets, however with several limitations. One of the limitations is that the algorithm cannot correctly mine nets with short loops, e.g., of length one or two tasks. That problem is remedied by the α+ algorithm based on an extended notion of trace completeness and two new relations between tasks. The β algorithm, which exploits the temporal span of tasks, i.e., the interval between the start and end of tasks, can be used to discover short loops.

Another limitation of the α algorithm and its derivatives is that they cannot detect all cases of concurrency in a business process, Concurrent tasks in SWF-nets are represented by means of a construct involving auxiliary AND-split (&-s) and AND-join (&-j) tasks. The α algorithm can mine processes with AND-split tasks only if the two auxiliary tasks, the AND-split and the AND-join tasks, have been recorded explicitly in the trace.

However, it can be expected that traces do not contain explicit AND-splits and AND-join tasks, because they do not correspond to actual tasks in the business process. Whenever parallel execution has been performed in a conventional IT system, the logic to initiate the parallel execution and the logic to synchronize its completion is usually not readily apparent. It is precisely the objective of the process raining algorithm to extract this logic and model it explicitly.

When explicit AND-splits and AND-joins are absent from the trace, which is expected to be the typical situation, the mining algorithm would have to deal with implicitly concurrent business processes. In numerous cases, the α algorithm and its descendants have difficulties in handling implicit concurrent execution.

There are several possible explanations of why implicit concurrency is challenging for the α algorithm and its extensions. The first is in the nature of SWF-nets as process representations. Although SWF-nets are very powerful and versatile in terms of the type of processes that can be represented, there is an inherent asymmetry in the way AND-blocks and OR-blocks are represented. Because the α algorithm does not generate new tasks, other than those already present in the trace, it cannot generate explicit AND-blocks.

A second possible explanation lies in the way the α algorithm constructs the WF-net. The algorithm identifies sets of tasks which are in the # and → relations between each other, but never analyzes tasks that have the ∥ relation between each other. The ∥ relation is indicative of possible concurrency, but the algorithms never identifies this concurrency as a step of their operation, rather, concurrent tasks end up being represented as such merely as a side effect of placing the tasks in the correct sequential or exclusive-choice order.

The above analysis suggests that it is worthwhile to provide alternative representation and mining methods that can handle implicit concurrency, while still providing a solution that is based on constructed compact relation tables from task execution traces.

Another desirable property of such methods would be more favorable computational complexity. The α algorithms and its derivatives are usually exponential in the number of tasks N, because they involve search within the space of all pairs of sets of tasks, i.e., the powerset of the set of all tasks. For practical purposes, a mining algorithm of low-degree polynomial complexity, e.g., O(N³) would be much more desirable.

### SUMMARY OF THE INVENTION

The embodiments of the invention provide a method for modeling a business process with a hierarchical workflow tree. The workflow tree facilitates mining of the model where parallel execution of two or more sub-processes has not been represented explicitly in traces obtain from the execution of tasks in the business process.

The invention provides an efficient business process mining (model construction) method. The method is based on the provable property of workflow trees that two tasks are siblings in the tree if and only if the two tasks have respective identical task relations with each and every other task in the business process.

Specifically, the method can construct a model of processes from traces with implicit concurrency. The invention provides a solution to this problem in the form of a novel representation for business processes, and an associated method for mining (constructing) such models from the traces.

The model is designed to facilitate mining of processes with implicit concurrency. The model is also fully compatible with the most common business process modeling languages and their underlying formalisms, such as BPMN, UML Activity Diagrams, and Workflow nets (WF-nets), and can easily be converted to any of them.

### BRIEF DESCRIPTION OF THE DRAWINGS

FIGS. 1 and 2 are block diagrams of Petri-nets with notations according to the embodiments of the invention;

FIG. 3 is a block diagram of a workflow-net that, can be recovered by embodiments of the invention but not by conventional algorithms;

FIG. 4 is a block diagram of a workflow net with sequential execution according to embodiments of the invention;

FIGS. 5A and 5B are block diagrams of iteration blocks according to embodiment of the invention;

FIG. 6 is a block diagram of a workflow corresponding to the workflow net of FIG. 3;

FIG. 7 is a flow diagram of a method for modeling a business process according to an embodiment of the invention; and

FIG. 8 is a flow diagram of detailed steps of the method of FIG. 7.

### DETAILED DESCRIPTION OF THE PREFERRED EMBODIMENT

The embodiments of our invention provide a method for representing a business process in an enterprise to a user as a model in the form of a workflow tree suitable for analysis. The representation is based on a hierarchical organization of the business process in the enterprise.

The representation is in the form of an ordered tree of nodes. The tree includes task and relation nodes. The bottom level leaf nodes of the tree represent tasks executed by the business process. The internal relation nodes of the tree represent functional execution relationships between the tasks.

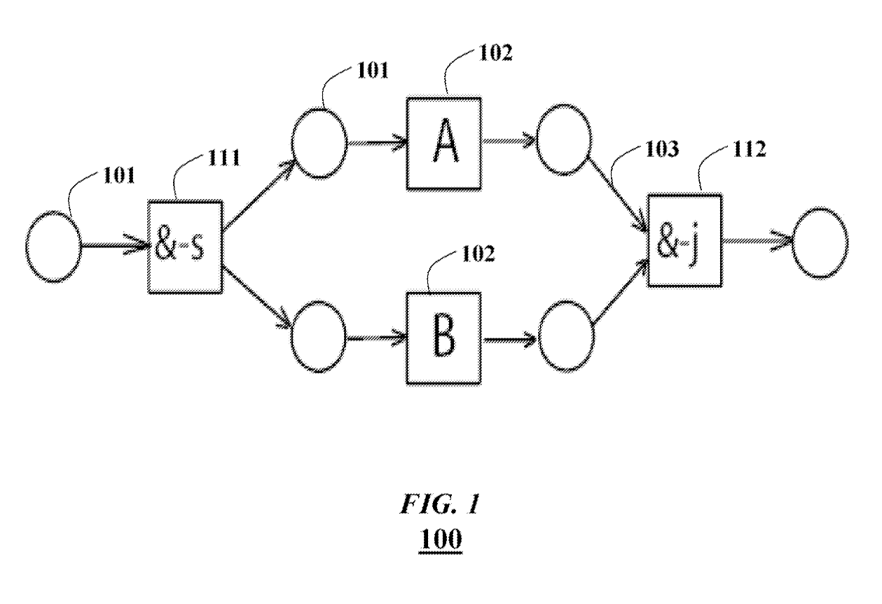

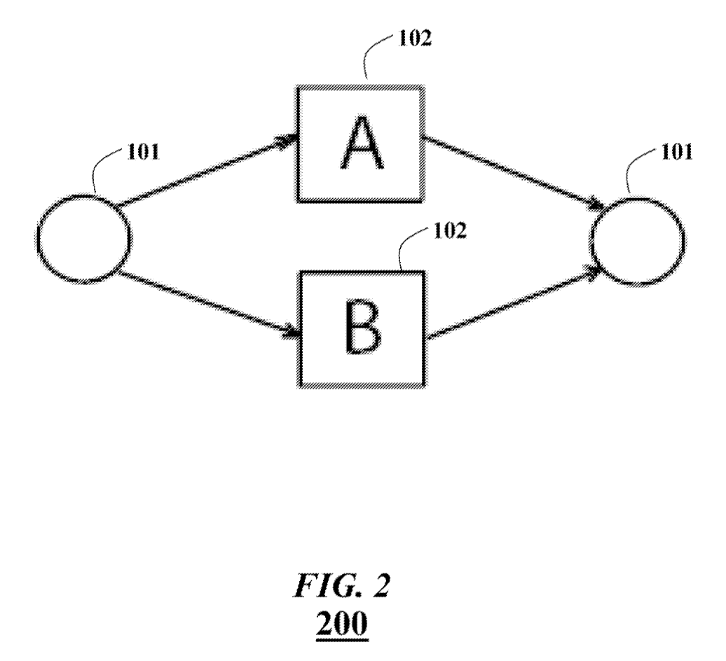

Our trees have four types of relation nodes: parallel (AND), selection (OR), sequence (SEQ), and iteration (ITER). The meaning of the AND and OR relation nodes is shown in FIGS. 1 and 2, using the Petri net notation. In the Figures, circles 101 are places, squares 102 are transitions or tasks, and directed arcs connect the places to the tasks. The tasks labeled &-s 111 and &-j 112 are auxiliary tasks, respectively AND-split and AND-join, and have the sole purpose of explicitly specifying concurrency of execution. The place from which an arc runs to a task is called the input place of the tasks. The place to which the are runs from a task is called the output place of the task.

FIG. 1 is a WF-net 100 that represents parallel (AND) execution of tasks A and B. FIG. 2 is a WF-net 200 that represents exclusive selection (OR), i.e., either task A or task B is executed, but not both.

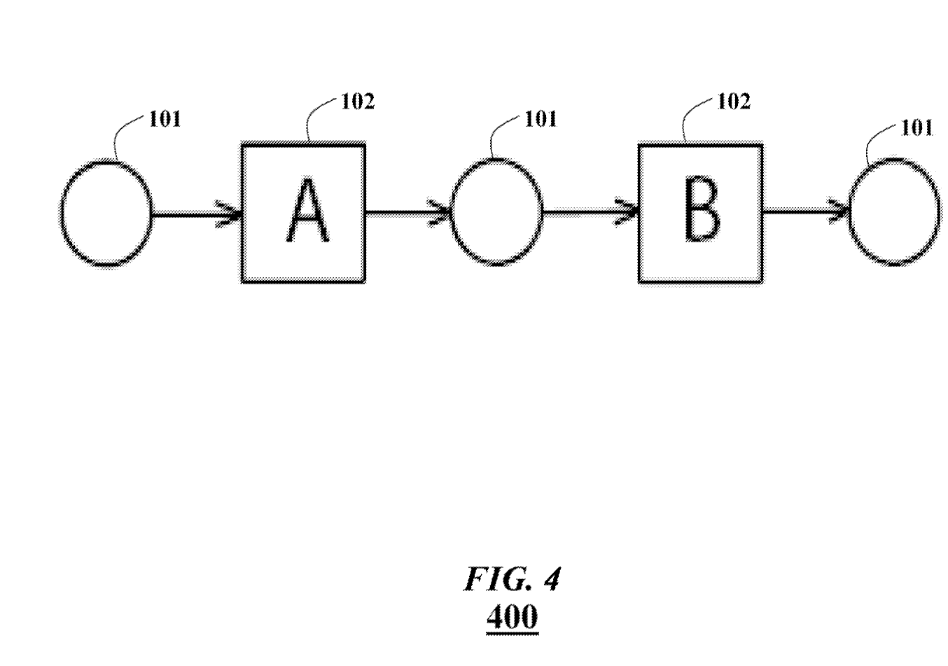

The meaning of the SEQ relationship is shown in FIG. 4. FIG. 4 shows a WF-net 400 that specifies sequential execution, i.e., tasks A and B are always executed strictly in order, i.e., task A always executes before task B.

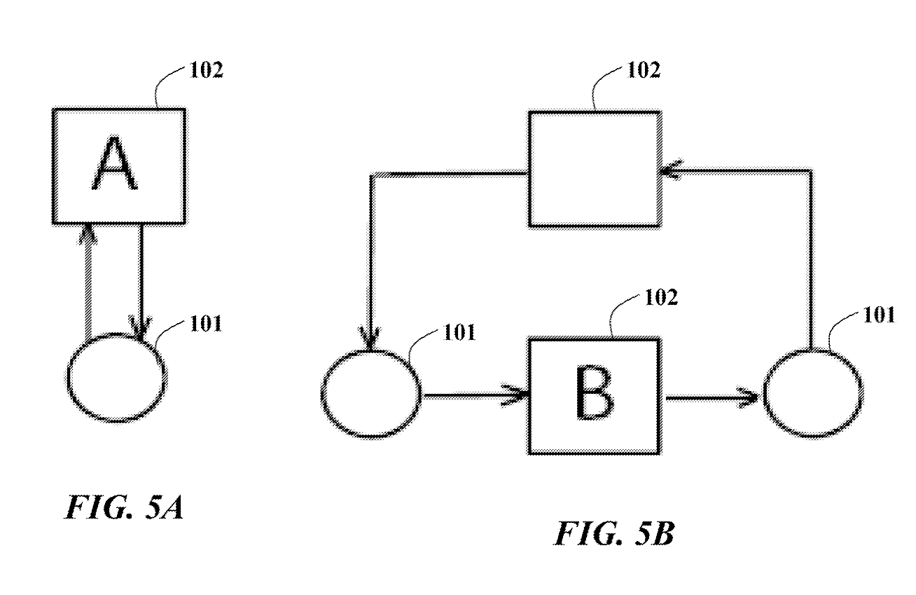

The ITER block has two possible definitions, depending on whether zero executions of a task are allowed, or the task has to be executed at least once. The two alternative definitions are shown in FIGS. 5A-5B. The WF-net in FIG. 5A allows zero or more executions of task A, while the WF-net in FIG. 5B specifies that task B should be executed at least once, and possibly many more times.

Our constructs are different than those used by van der Aalst and van Hee. They use an iteration block, which can involve only one tasks.

By starting with one of these constructs, and recursively substituting its component tasks with compound nodes of more tasks, a large class of workflow nets can be constructed. We formalize this intuition in our workflow trees. We also describe a way to convert a workflow tree (WF-tree) to a conventional SWF-net.

By traversing the WF-tree in any convenient order, each tree node is replaced by its corresponding Petri net, as described above, and if any of the children of this node are nodes themselves, then the procedure is recursively repeated until all tasks in the resulting SWF-net are atomic tasks.

The specific representation in a tree-like form enables us to analyze and identify the properties of this representation that are useful for the purposes of business process mining. In particular, we are interested in the relations between pairs of tasks that are entailed by this representation.

We define a set of functional relations AND, OR, SEQ, and ITER between tasks that are n-ary, and can hold between two or more tasks. Any two tasks in the WF-tree must have one of these relations between each other. In this example, the relation is binary. We specify that the binary relation between a pair of tasks in a WF-tree is determined by the relation node of the tree that is the least common ancestor (LCA) of the pair of tasks.

The LCA for two nodes in a tree has both nodes as descendants, and these two nodes are in two different branches of the LCA node. In other words, the LCA is also the node farthest from the root of the tree that has both of the two descendant nodes as ancestors.

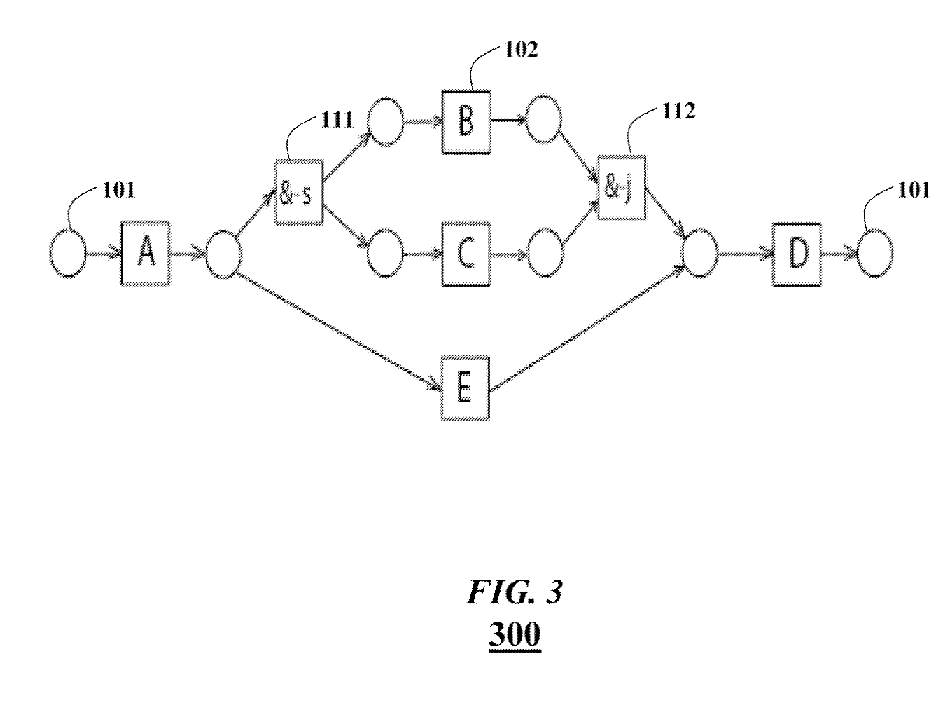

FIG. 3 shows an example WF-net 300 that can be recovered by our method but not by the conventional α algorithm when the auxiliary tasks &-s 111 and &-j 112 are missing from the trace, which would be a likely case in a real business process as described above.

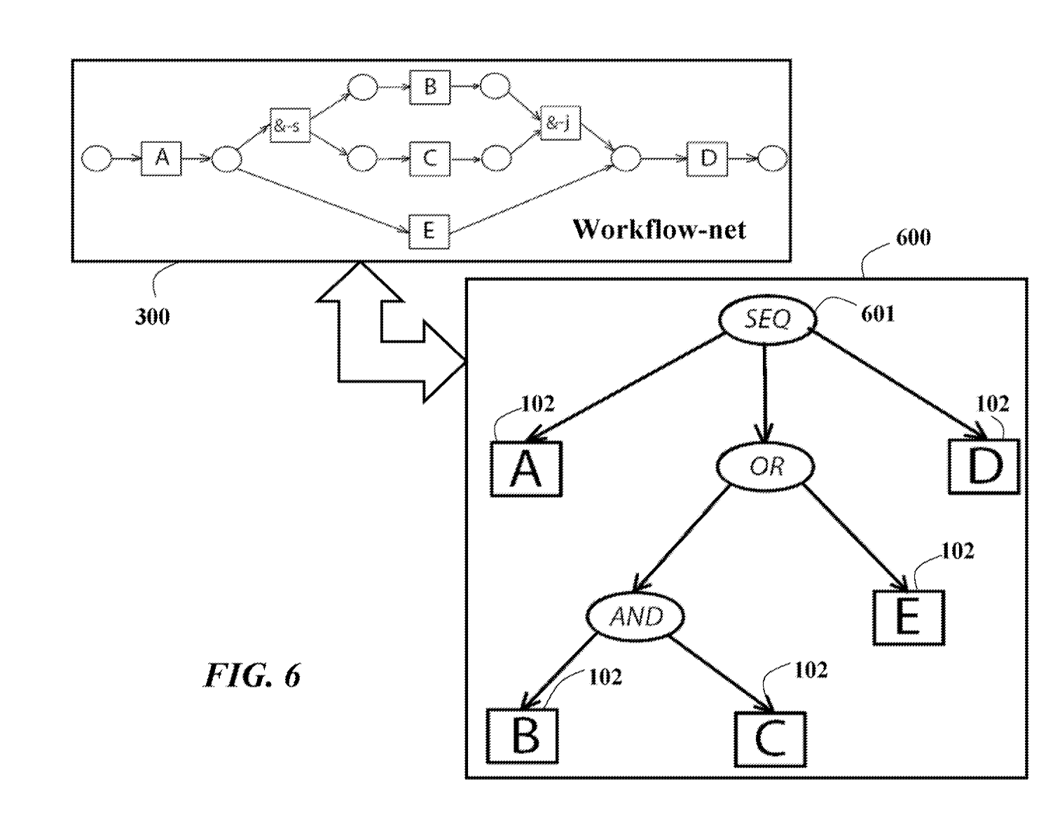

FIG. 6 shows a WF-tree 600 corresponding to the WF-net of FIG. 3. The blocks represent bottom level task nodes, and the ovals internal relation nodes. The ovals 601 are the functional nodes that define the relationships of the descendant tasks 102, which are all leaf nodes. For example, the task A is in the SEQ relation with tasks B, C, E and D. Task B is in the OR relationship with task E and the SEQ relationship with task D, and so forth.

In the general case, it is possible to have process models with nested blocks of the same type, for example an OR block nested immediately within another OR block. In the corresponding WF-tree, this would be expressed as one OR node having as a child, i.e., a direct descendant, another OR node. While certainly possible and valid, such WF-trees are redundant, and it is usually desirable to eliminate this redundancy.

We define a compact workflow tree (CWF-tree) to be a workflow tree where no two nodes with the same relationship label have a direct parent/child relationship. Compacting a redundant WF-tree to a CWF-tree is performed by traversing the WF-tree using any suitable, e.g., depth-first, breadth-first, etc., post-order walk of the WF-tree. When the current node has a child node with the same label, we eliminate the child node and add its children directly as children of the current node.

We also stipulate that apart from the ITER node, all other nodes in the tree must have at least two children nodes. In case such a node does not have two children, the childless node can be eliminated from the tree, without loss of correctness.

Before analyzing the properties of the described relations, we note that as a corollary of this specification and the nature of our specific definition of an iterative block, no two tasks can be in the ITER relation. This is due to the fact that a tree node labeled with ITER always has only one child, and hence cannot be the LCA of any pair of distinct tasks. This is true regardless of which alternative definition of an ITER block is chosen from the two shown in FIGS. 5A-5B.

The remaining three relations have the following properties. When these relations are binary, the binary AND and OR are transitive and symmetric, while the binary SEQ is transitive and asymmetric ((aSEQb) [symbol] (bSEQa)).

Ternary relations can be defined by aRb̂bRc [symbol] R(a, b, c), whereas arbitrary n-ary relations have the property

R(a₁, a₂, . . . aₙ₋₁)̂aₙ₋₁Raₙ [symbol] R(a₁, a₂, . . . , , aₙ₋₁aₙ).

Here, R can represent any of the three relations AND, OR, and SEQ. Note that in combination with, the asymmetry of the binary SEQ relation, the n-ary SEQ relation is guaranteed to hold only between arguments in the correct order, while the symmetry of the binary AND and OR ensure that their n-ary counterparts hold for an arbitrary order of their arguments.

We also define the symmetric linear relation LIN, such that aLINb iff aSEQbνbSEQa. The meaning of this relation is a linear order. It holds true between two tasks when one of the tasks follows the other in execution. Note also that if three or more tasks are in the same relation, if is not necessarily true that each pair of tasks has the same LCA, because more than one tree node can be labeled with the same label. It is completely possible that three or more tasks are in the same relation, but are not descendants of three different children of the same node. What is true, though, is that any three tasks a, b, and c of the same WF-tree can have at most two distinct relations R₁, R₂ from the set {AND, OR, LIN}.

We state the following three Lemmas and one Theorem. The proofs are given the Appendices.

Lemma I: (aR₁b̂bR₂c) [symbol] (aR₁cνaR₂c), for R₁, R₂ ε {AND, OR, LIN}.

Due to the symmetry of the three relations AND, OR, and LIN, this Lemma holds for all possible symmetric exchanges in the order of tasks in these relations. A direct corollary of this Lemma, in one respective instantiation as regards to relation symmetry, is that if two tasks a and b are in relation R₁(aR₁b), and one of the tasks (a) is in relation R₂ with some third task c(aR₂c), then there are only two possibilities for the relation between b and c. That is, the relation is either bR₁c or bR₂c. From the Lemma, the former case (bR₁c) holds when the LCA of tasks a and b is a descendant of the LCA of a and c, while the latter case (bR₂c) holds when the LCA of a and c is a descendant of the LCA of a and b.

The latter case is of particular interest, as described below. It is true that the logical implication also holds in the other direction, even regardless of the exact relation between tasks a and b. By defining the LCA(.,.) to be a function that returns the node of a WF-tree that is the LCA of its two arguments, and the binary relation Descendant such that Descendant(d, a) holds true when node d is a descendant of node a, we can show that if tasks nodes a and b share the same relation node R respectively with every other task c, it is necessarily true that their LCA is a descendant of their respective LCAs with the other task.

Lemma II: aR₁b̂aR₂ĉbR₂ĉ(R₁≢R₂) [symbol] Descendant[LCA(a, b), LCA(a, c)].

The same stipulation about the validity of this Lemma with respect to the symmetry of R₁ and R₂ applies here, too. It follows immediately that LCA(a, b) is a descendant of LCA(b, c), as well. We also prove that LCA(a, c)≡LCA(b, c).

Lemma III: (aR₁b̂aR₂ĉbR₂ĉ(R₁≢R₂)) [symbol] (LCA(a, c)≡LCA(b, c)).

Consequently, the following relation condition is true. A first task and a second task of a pair of tasks are child nodes (direct descendants) of the same relation node if and only if the first task and the second task are in an identical relation with every other task at a least common ancestor relation node of the first and second tasks and the other task.

This property holds for compact workflow trees that do not contain redundant parent/child nodes of the same label, and also do not contain intermediate nodes of type ITER.

This property is expressed by the following theorem.

Theorem I; (∀_{c}∃_{R}aRĉbRc) [symbol] [∃_{L}Child(a, L)̂Child(b ,L)].

This theorem indicates that we can identify a pair of child tasks that must have the same parent relation node in the CWF-tree by comparing their respective relations with every other task in the tree. If the relationships are identical, then the two tasks must share the same parent relation node. We use this theorem to construct a workflow tree. The tree can be displayed to a user to better understand and analyze a complex business process.

Model Construction

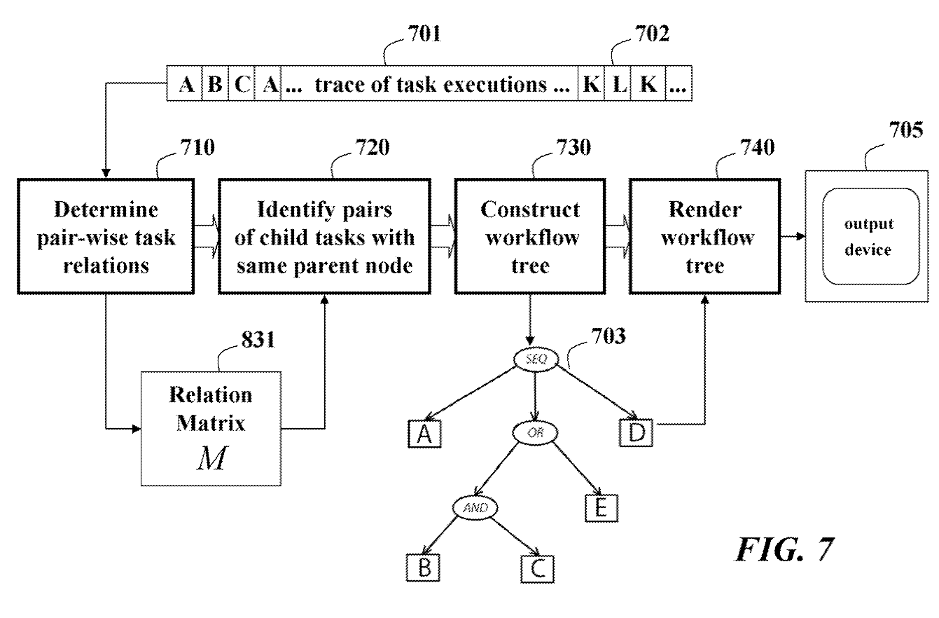

FIG. 7 shows a method for constructing a model of a business process according to an embodiment of our invention. We begin with a trace 701 of an execution of tasks 702 corresponding to a business process. The trace can be obtained in any convenient manner. The trace is defined as a sequence of tasks that are executed while processing a work-case. Typically, such traces will be recorded by usual enterprise information technology system in the normal course of their operation.

We determine 710 for each possible pair of task whether the tasks in each pair have an identical relation with every other task in the trace, and each pair of tasks and the other tasks have a least common ancestor. The determining is performed using a relation matrix M 831 described in greater detail below. In this and other matrices described below, elements are arranged in rows and columns.

If the above condition is true, then we identify 720 the pair of tasks as sibling task nodes of a parent node.

Identifying the child nodes and parent nodes for all tasks in the trace 701 enables us to construct 730 a workflow tree 703. It should be noted, that in the computer sciences trees are usually depicted in an up-side-down manner with the root at the top and the leaves at the bottom. In the preferred embodiment, the tree is constructed in a bottom-up manner beginning with the leaf nodes and ending at the root following the above convention.

We can then render 740 the tree 703 on an output device 705 for further analysis by a user.

Detailed Construction Steps

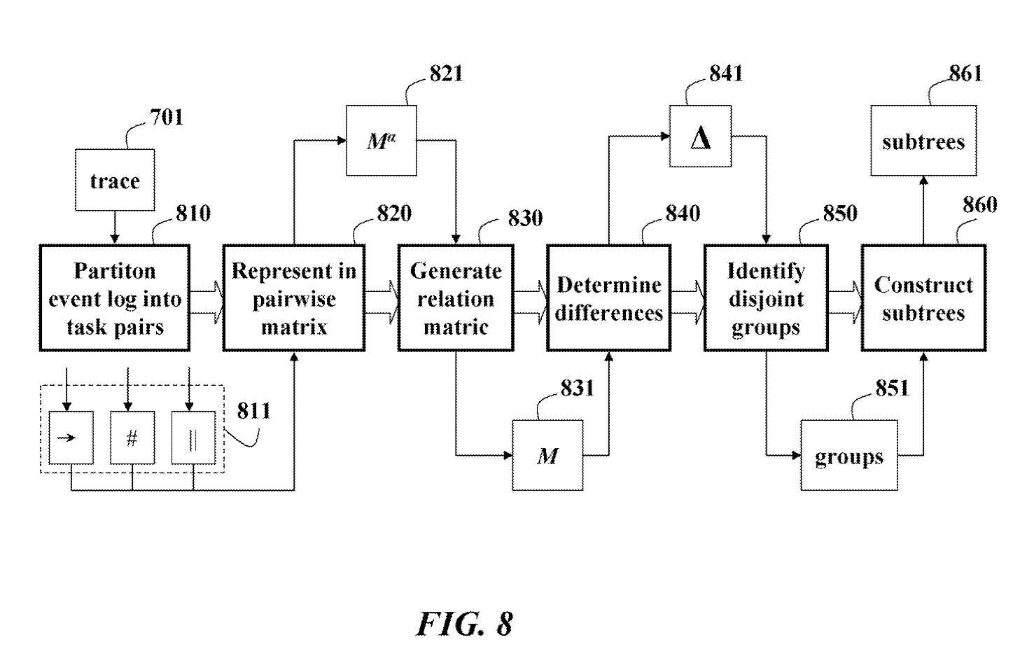

As shown in FIG. 8, all possible pairwise relations between two tasks in the trace are determined s follows.

The binary relation AND is identical to the relation ∥ used in the conventional α algorithm:

aANDb [symbol] a∥h.

The relation SEQ is based on the relation > from that algorithm

(a>b) [symbol] aSEQb,

However, unlike the conventional relationship, our relationship is transitive and is more comprehensive. From the above implication and the transitivity property

aSEQb̂bSEQc [symbol] aSEQc,

it follows that

aSEQb̂(b>c) [symbol] aSEQc.

That is, the relation SEQ is simply the transitive closure of >, and can be found by any suitable procedure, for example, the Floyd-Warshall algorithm. The Floyd-Warshall algorithm finds shortest paths in a weighted, directed graph.

As described above, aLINb holds true if aSEQbμbSEQa, that is, a and b are in linear order if either b follows a or a follows b. Finally, the OR relation is based on the # relation, but is much more limited. It holds only when the SEQ relation does not hold:

aORb [symbol] a#b̂ [symbol] (aLINb).

Partition Tasks

Consequently, we partition 810 a set of all possible task pairs (tᵢ, tⱼ) from the trace 701 into three subsets 811 of task pairs that obey three relations AND (∥), OR (#), and SEQ, respectively. This is done by first establishing the > relation first by performing a single scan of all traces in the execution trace. The relation > between two tasks holds true when there exists at least one trace where the first relation is immediately followed by the second relation. The computational complexity of this step is linear in the length of the trace and independent of the number of tasks.

Pairwise Matrix

The resulting partition of task pairs are represented 810 in a pairwise matrix M^{α} where an entry M^{α}_{i,j} are labeled with the relation for the pair of tasks (tᵢ, tⱼ). The diagonal entries of the pairwise matrix M^{α}_{i,i} are undefined and excluded from consideration. Note that the matrix M^{α} is not symmetric, in general.

Relation Matrix

Then, we generate 830 a relation matrix M 831 from the pairwise matrix M^{α} and the definitions described above. The order of filling the relation matrix M is strictly as described above: AND, SEQ, LIN, and OR (because LIN labels overwrite SEQ labels). The end result is a partition of the task pair set into three relation subsets labeled with AND, OR, and LIN. Again, the diagonal elements of the relation matrix M are undefined and excluded from consideration. Note that in contrast to the matrix M^{α}, the relation matrix M is symmetric.

Task Differences

Next, we determine 840 a difference matrix A 841 from each distinct pair of rows (i, j) in the relation matrix M, in which the difference Δ_{i,j} between two rows of the relation matrix M is determined by counting respective elements in an identical column that do not match, for each possible column k corresponding to a third task, according to

$${Δ}_{i , j} = {\sum }_{k = 1}^{N} δ ( i , j , k ) , \\ δ ( i , j , k ) ≃ \{ \begin{matrix}1 & iff i \neq k j \neq k {M}_{i , k} \neq {M}_{j , k} \\ 0 , & otherwise .\end{matrix} \qquad ( 1 )$$

If the difference Δ(i, j) is zero for a distinct pair of tasks (i, j), i≠j and a third task k, then the two tasks have identical respective relations with respect to all other tasks k. According to Theorem I applied in the forward direction, the two tasks must have the same parent node. In such case, we can construct a workflow subtree that has a root node labeled with M_{i,j}, and children tᵢ and tⱼ. When the difference is zero for more than one pair (excluding the symmetric difference Δ_{j,i} which is also necessarily zero because of the symmetry of the difference), there are two possible cases, depending on whether the cases involve overlapping tasks, or not.

In the workflow tree, when more than two task nodes have the same parent node, every pair of tasks (i, j) has pairwise distance Δ_{i,j}=0, from Theorem I applied in the reverse direction.

In contrast if

Δ_{i,j}=0̂Δ_{k,l}=0̂Δ_{i,k}≠0,

then it also follows that

Δ_{i,l}≠0̂Δ_{j,k}≠0̂Δ_{j,l}≠0,

i.e., pairs (i, j) and (k, l) form two disjoint subtrees with two different parent nodes. Of course, nothing precludes these two parent nodes from being labeled with the same relation. Depending on which of these situations is true, the correct number of disjoint workflow subtrees is constructed, as described below.

Grouping Tasks

Which of these two situations applies can be determined from a graph with N vertices corresponding to the tasks, and where edges exist only between pairs of vertexes (i, j) such that Δ_{i,j}=0. It can be seen that each separate set of tasks that share the same parent node forms a distinct group in this graph, and these groups are disjoint.

Identifying 850 these disjoint groups 851 can be done by scanning the difference matrix row-wise until a row i with all element(s) with differences equal to zero is found. This indicates that task tᵢ is a member of a group. From inspecting that row, ail tasks besides tᵢ that belong to this group can be identified, and their respective rows in the difference matrix can be marked by a flag as already processed. The row-wise scan continues until all rows are processed and all groups are identified.

Constructing Subtrees

After all groups have been found, a sub-tree 861 is constructed 860 for each group. The root of this subtree is labeled with the relation that holds among these tasks. Due to the semantics of WF-trees, a sub-tree is a composite task. The composite task can participate at a higher level of the tree just like any other atomic task. Because of this, we can generate a new task label for each sub-tree so identified.

The set of these new composite tasks is T_{new}. This set complements the initial set of atomic tasks T. The tasks tᵢ ε T_{new} are given successive ordinal numbers beyond N. Also, the atomic tasks that are members of one of the groups can be defined as T_{inc}. Each task in T_{inc} is a child of a member of the set of composite tasks T_{new}.

The next series of steps are similar to the one just described, only these steps work on a progressively modified active set of tasks. During each of these steps, the following sub-steps are performed:
1) The active set is modified to exclude the tasks that have already been included in some composite task: T_{act}:=T_{act}/T_{inc}. Their corresponding rows and columns in the difference matrix are marked as processed;
2) The set of active tasks is expanded to include the new composite tasks: T_{act}:=T_{act}∪T_{new}. Furthermore, rows and columns are allocated for the new tasks in the matrices M and Δ. Pointers are kept from each new task to its children;
3) For each new composite task tᵢ ε T_{new}, its relation with the other tasks tⱼ ε T_{act} is determined and stored in the matrix M_{i,j}. Task tₖ is one of the children of task tᵢ. When task tⱼ is an atomic task, M_{i,j}=M_{k,j}, i.e., the composite task has the same relation with a third task as any one of its children has with this third task. By construction, all of the children of tᵢ have the same relation with tⱼ. When task tⱼ is also a composite task, and tₗ is one of its children, then M_{i,j}=M_{k,l};
4) For each new composite task tᵢ ε T_{new}, its row difference with all other active tasks tⱼ ε T_{act} determined, similarly to Equation 1, but with the distinction that this difference is taken only with respect to active tasks:

$${Δ}_{i , j} = {\sum }_{k = 1 , {t}_{k} ∈ {T}_{act}}^{N} δ ( i , j , k ) . \qquad ( 2 )$$

5) Groups of tasks that have zero pairwise distance are identified exactly as described in step 3 above. New parent nodes for each of the groups are generated and labeled with the respective relation. Each of the nodes forms a new subtree and corresponds to a new composite task. Analogously to step 3, the subset of active tasks that are now included in some subtree is assigned to T_{inc}, and the set of new composite tasks is assigned to T_{new}.

The above five sub-steps are iterated until the set of active tasks T_{act} remaining after sub-step 2 includes only a single task. This task becomes the root of the workflow tree, and corresponds to the outermost block construct. The overall polynomial complexity of this series of steps is O(N³), which is considerably better than the exponential complexity of the prior art method.

The last step of the procedure reorders the children of all LIN nodes, so that the SEQ relation holds, and re-label those nodes with the label SEQ. This completes the construction 730 of the workflow tree 703. Because each composite node has at least two children, this workflow tree is also compact.

### EFFECT OF THE INVENTION

The invention provides a method for representing business processes as workflow trees. The workflow tree matches the hierarchical organization of most business processes used in practice. In contrast with prior art business process models, workflow trees have precise semantics and properties, which derive directly from their tree-like representation.

These properties are leveraged to provide an efficient mining method that can recover business process models with concurrent tasks that have not been specified as such explicitly in traces. The method operates by analyzing and comparing the mutual relations between pairs of tasks, suitably organized in matrices.

This computational efficiency is achieved at the expense of a slight sacrifice in the representational power of workflow trees in comparison to other formalisms, such as workflow nets. The set of processes that can be represented by workflow trees is a strict subset of the set of models that can be represented by workflow nets.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A computer implemented method for modeling a business process, comprising the steps of:
determining, for each possible pair of tasks in a trace of executions of N tasks corresponding to a business process, whether the tasks in each pair have an identical relation condition with every other task in the trace;
identifying the pair of tasks as child task nodes of an associated parent relation node if the identical relation condition is true;
constructing a workflow tree from all identified child task of the associated corresponding parent relation nodes; and
rendering the workflow tree.

2. The method of claim 1, in which the execution of the tasks is implicitly concurrent.

3. The method of claim 1, in which the relation nodes include a parallel (AND) relation, a selection (OR) relation, a linear (LIN) relation, and a sequence (SEQ) relation.

4. The method of claim 1, further comprising;
compacting the workflow tree.

5. The method of claim 3, in which the relation SEQ is transitive.

6. The method of claim 3, in which the constructing further comprises:
partitioning all possible pairs of tasks into three subset task pairs that obey the relations AND, OR, and SEQ.

7. The method of claim 6, further comprising:
representing the three subset of tasks in a pairwise matrix, and in which each entry in the pairwise matrix is labeled with the relation of the pair;
generating a relation, matrix from the pairwise matrix, and in which an order of filling the relation matrix is according to the relations AND, SEQ, OR, and LIN;
determining a difference matrix between each pair of rows from the relation matrix;
identifying subgroups of disjoint tasks form the difference matrix to construct disjoint subtrees; and
combining the subtrees in a bottom-up manner to form the workflow tree.

8. The method of claim 7, in which the difference matrix is Δ, and in which a Δ_{i,j} difference between two rows i,j of the relation matrix M is determined by counting respective elements in an identical column that do not match, for each possible column, k corresponding to a third task, according to
$${Δ}_{i , j} = {\sum }_{k = 1}^{N} δ ( i , j , k ) , \\ δ ( i , j , k ) ≃ \{ \begin{matrix}1 & iff i \neq k j \neq k {M}_{i , k} \neq {M}_{j , k} \\ 0 , & otherwise .\end{matrix} \qquad$$

9. The method of claim 8, where disjoint sub-trees are identified by inspecting all pairwise entries in the difference matrix, and a pair of tasks that have non-zero entry in the difference matrix are placed in separate sub-trees each, while a pair of tasks that have a corresponding zero entry in the difference matrix are placed both in the same sub-tree.

10. The method of claim 7, further comprising:
constructing the workflow tree in a bottom-up manner by first constructing lowest relation nodes of the workflow tree that have only tasks as child nodes, and proceeding upwards in the workflow tree by adding additional relation nodes that include as child nodes previously constructed relation nodes until a root relation node of the workflow tree is constructed.

11. The method of claim 1, in which the constructing of the workflow tree is in a bottom-up manner.
